(19) United States
(12) Patent Application Publication
(10) Pub. No.: US 2009/0268235 A1
(43) Pub. Date: Oct. 29, 2009

(54) TERMINAL APPARATUS FOR PRINTER DRIVER PACKAGE FORMATION AND PRINTER DRIVER PACKAGE FORMATION METHOD

(75) Inventor: Sang-min LEE, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/273,769

(22) Filed: Nov. 19, 2008

(30) Foreign Application Priority Data
Apr. 23, 2008 (KR) 2008-37587

(51) Int. Cl. G06F 3/12

(52) U.S. Cl. 358/1.15

(57) ABSTRACT

A method of generating a printer driver package, the method including: receiving a command to generate the printer driver package; collecting data to be included in the printer driver package in response to the command; and generating the printer driver package based on a printer driver pre-installed in the terminal apparatus using the collected data. Accordingly, a printer driver package is generated using the updated or modified printer driver, so user convenience can be improved.

### CROSS-REFERENCE TO RELATED APPLICATION

This application claims all benefits accruing under 35 U.S.C. §119 from Korean Application No. 2008-37587, filed Apr. 23, 2008, in the Korean Intellectual Property Office, the disclosure of which is incorporated herein by reference.

### BACKGROUND OF THE INVENTION

1. Field of the Invention

Aspects of the present invention relate to a terminal apparatus for printer driver package formation and a printer driver package formation method, and more particularly, to a terminal apparatus that generates a printer driver package using a printer driver of an image forming apparatus currently used in the terminal apparatus, and a printer driver package formation method.

2. Description of the Related Art

Generally, printer drivers for image forming apparatuses can be downloaded from homepages of respective manufacturers of the image forming apparatuses, or can be directly installed on a user's terminal apparatus using a storage medium (such as a compact disc read-only memory (CD-ROM)) provided by the respective manufacturers of the image forming apparatuses. If a user wishes to install a printer driver optimally configured for his or her terminal apparatus environment and for which a live update has been performed, the user must inconveniently install a default printer driver of the image forming apparatus that is provided by the manufacturer in a desired terminal apparatus, perform a live update of the printer driver, and optimize the configuration for the terminal apparatus environment.

Furthermore, in an environment in which a universal print driver (UPD) is used, an administrator of a network or a domain produces a printer driver distribution of an image forming apparatus that is adapted to the network or the domain using an install program provided by the manufacturer of the image forming apparatus, and provides the printer driver distribution to each terminal apparatus connected to the network. The administrator generally identifies whether the printer driver distribution is a distribution desired by each terminal apparatus (that is, whether there is an error) after producing the printer driver distribution.

If there are no errors, the produced printer driver distribution is provided to each terminal apparatus. However, if the printer driver distribution is produced to have a configuration that is not desired by each terminal apparatus due, for example, to confusion of the administrator, the administrator must again produce a printer driver distribution and identify whether the printer driver distribution is a distribution desired by each terminal apparatus.

Therefore, there is a need for methods for a user to install a print driver with greater ease and convenience.

### SUMMARY OF THE INVENTION

Aspects of the present invention provide a terminal apparatus that generates a printer driver package having the same settings as a printer driver of an image forming apparatus that is currently installed and used in a user's terminal apparatus, and a printer driver package formation method.

Additional aspects and/or advantages of the invention will be set forth in part in the description which follows and, in part, will be obvious from the description, or may be learned by practice of the invention.

In accordance with an example embodiment of the present invention, there is provided a method of generating a printer driver package in a terminal apparatus that is connected to an image forming apparatus. Such a method includes: receiving a command to generate the printer driver package; collecting data to be included in the printer driver package in response to the command; and generating the printer driver package based on a printer driver pre-installed in the terminal apparatus using the collected data.

According to an aspect of the present invention, the method may further include externally transmitting the generated printer driver package.

According to an aspect of the present invention, the receiving of the command to generate the printer driver package may include displaying a user interface screen to select a printer driver installed in the terminal apparatus from among one or more printer drivers.

According to an aspect of the present invention, the generating of the printer driver package may include generating the printer driver package to have a same configuration as the pre-installed printer driver.

According to an aspect of the present invention, the generated printer driver package may be converted to an executable file format.

According to an aspect of the present invention, the command to generate the printer driver package may be input by selecting a menu displayed on a user interface screen that is generated by executing a printer driver program or an application program.

According to an aspect of the present invention, the data may include registry data of the pre-installed printer driver when the printer driver is installed in the terminal apparatus, and/or a file relating to the pre-installed printer driver.

According to an aspect of the present invention, the collecting of the data may include searching for a printer driver installation information file from among registry data of the pre-installed printer driver, and analyzing the searched printer driver installation information file to copy a list of files generated when the pre-installed printer driver was installed, a list of files generated after the pre-installed printer driver was installed, and registry data.

According to an aspect of the present invention, the generating of the printer driver package may include generating a new printer driver installation information file including installation information of the files generated after the pre-installed printer driver was installed to the printer driver installation information file, and generating the printer driver package by packaging the new printer driver installation information file with the copied data.

According to another embodiment of the present invention, there is provided a computer-readable recording medium which stores a program to execute the method for generating a printer driver package as described above.

In accordance with another example embodiment of the present invention, there is provided a terminal apparatus connected to an image forming apparatus. Such a terminal apparatus includes: a user interface unit to receive a command to generate a printer driver package for the image forming apparatus; and a control unit to collect data used to generate the printer driver package when the command is input, and to generate the printer driver package based on a printer driver pre-installed in the terminal apparatus using the collected data.

According to an aspect of the present invention, the apparatus may further include a storage unit to store registry data of the pre-installed printer driver, and a file relating to the pre-installed printer driver.

According to an aspect of the present invention, the user interface unit may display a user interface screen to select a printer driver installed in the terminal apparatus if a printer driver program or an application program is executed.

According to an aspect of the present invention, the control unit may generate the printer driver package to have a same configuration as the pre-installed printer driver.

According to an aspect of the present invention, the control unit may convert the generated printer driver package to an executable file format.

According to an aspect of the present invention, the collected data may include at least one of the registry data of the pre-installed printer driver when the printer driver was installed in the terminal apparatus, and the file relating to the pre-installed printer driver.

According to an aspect of the present invention, the control unit: may copy files generated when the pre-installed printer driver was installed, files generated after the pre-installed printer driver was installed, and registry data by searching for a printer driver installation information file from among the registry data of the pre-installed printer driver and analyzing the searched printer driver installation information file; may generate a new printer driver installation information file including installation information of the files generated after the pre-installed printer driver was installed to the printer driver installation information file; and may generate the printer driver package by packaging the new printer driver installation information file with the copied data.

In accordance with another example embodiment of the present invention, there is provided a method of generating a printer driver package in a terminal apparatus that is connected to an image forming apparatus. Such a method includes: collecting data to be included in the printer driver package for the image forming apparatus; and generating the printer driver package based on a printer driver pre-installed in the terminal apparatus using the collected data.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a flow chart illustrating a printer driver package formation method according to an example embodiment of the present invention;

FIG. 2 is a flow chart illustrating in greater detail the printer driver package formation method of FIG. 1;

FIG. 3 is a block diagram illustrating a terminal apparatus to generate a printer driver package according to an example embodiment of the present invention;

FIGS. 4A and 4B illustrate examples of screens of a user interface unit used in a terminal apparatus according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

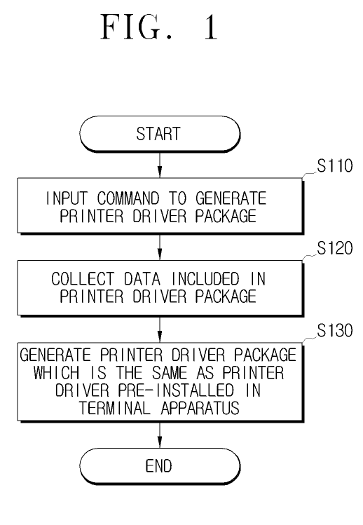

FIG. 1 is a flow chart illustrating a printer driver package formation method according to an example embodiment of the present invention. Referring to FIG. 1, in the printer driver package formation method, a terminal apparatus (such as a personal computer, a laptop computer, a workstation, a mobile phone, a personal digital assistant, etc.) that is connected to an image forming apparatus (such as a printer, a facsimile, a photocopier, a multi-functional peripheral, etc.) receives a command to generate a printer driver package in operation S110. Accordingly, the terminal apparatus collects data used to generate the printer driver package in operation S120, and the terminal apparatus generates a printer driver package, having the same configuration as a printer driver preset in the terminal apparatus, using the collected data in operation S130.

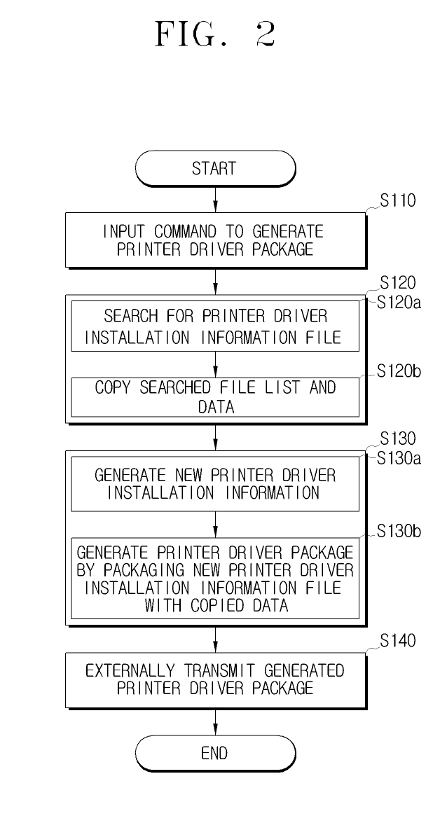

FIG. 2 is a flow chart illustrating in greater detail the printer driver package formation method of FIG. 1. Referring to FIG. 2, in addition to the driver package formation method illustrated in FIG. 1, the printer driver package formation method may further include transmitting the generated printer driver package externally in operation S140.

Furthermore, in the collecting of the data used to generate the printer driver package (operation S120), a printer driver installation information file is searched for among registry information of the pre-installed printer driver in operation S120a. Then, the printer driver installation information file is analyzed so that a list of files generated when the printer driver was installed, a list of files generated after the printer driver was installed, and registry data can be searched and copied in operation S120b.

Also, in the generating of the printer driver package (operation S130), a new printer driver installation information file is generated with the files generated after the printer driver was installed in operation S130a. Accordingly, the new printer driver installation information file and the copied data are packaged so that a printer driver package can be generated in operation S130b.

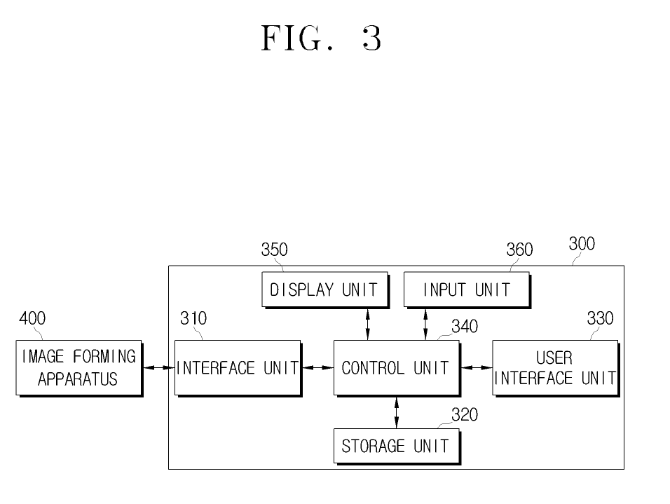

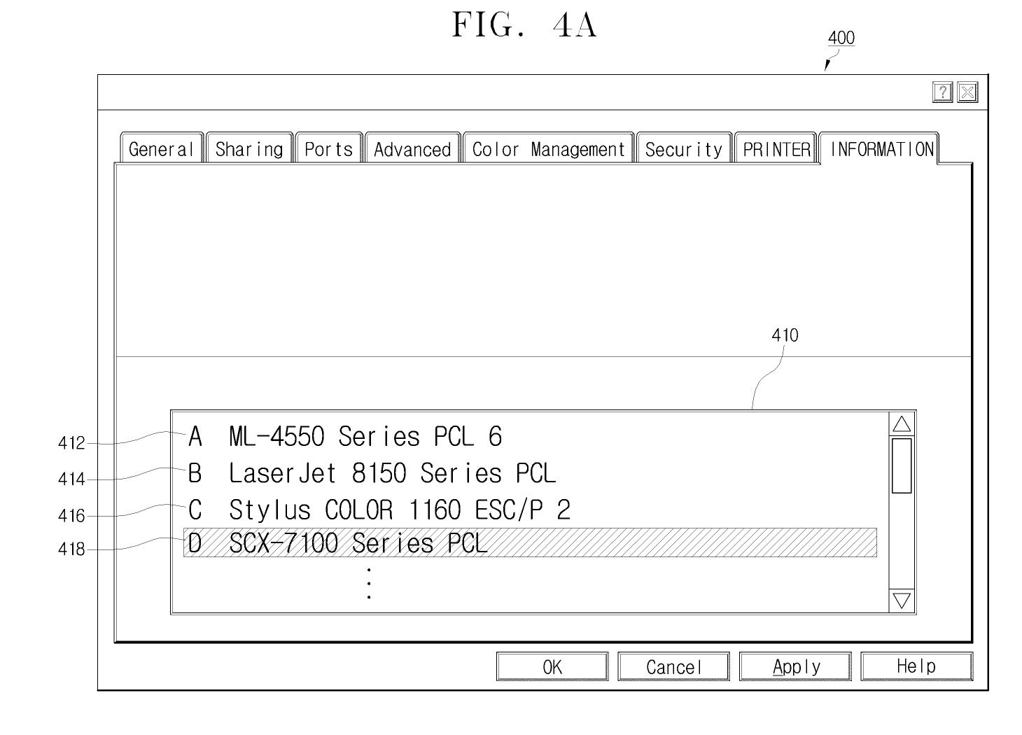

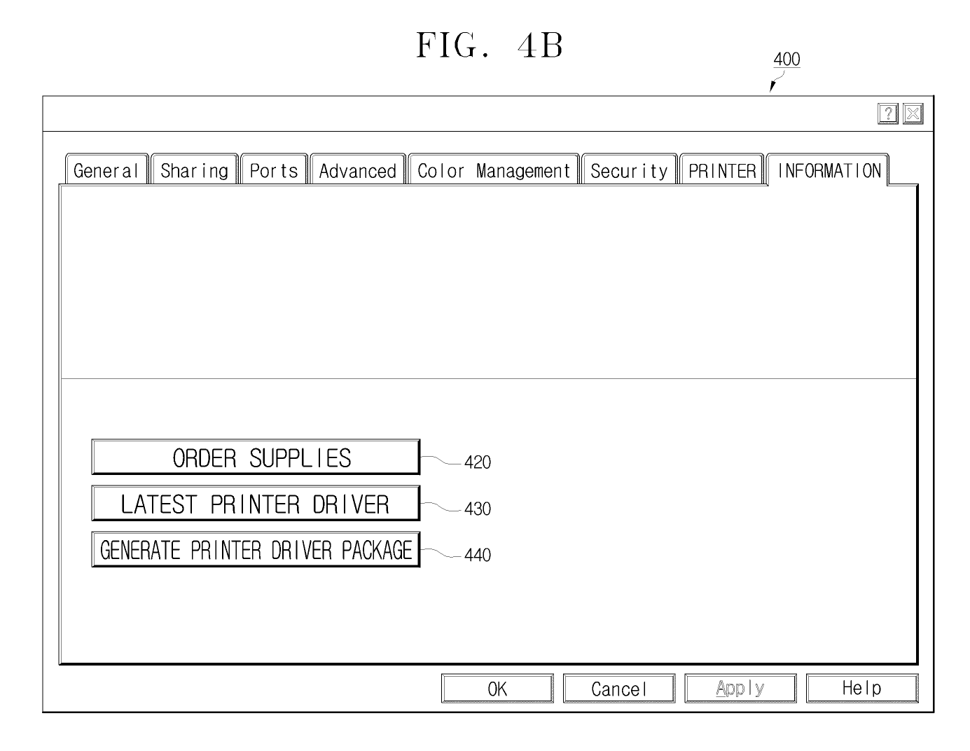

A more detailed description of the printer driver package formation method according to an example embodiment of the present invention will be described below with reference to FIGS. 3, 4A, and 4B. FIG. 3 is a block diagram illustrating a terminal apparatus to generate a printer driver package according to an example embodiment of the present invention, and FIGS. 4A and 4B illustrate examples of screens of a user interface unit used in the terminal apparatus according to an example embodiment of the present invention.

Referring to FIGS. 3, 4A, and 4B, the terminal apparatus 300 to generate a printer driver package includes an interface unit 310, a storage unit 320, a user interface unit 330, and a control unit 340. In addition, the terminal apparatus 300 further includes a display unit 350 (such as a monitor), and an input unit 360 (such as a keyboard or a mouse). According to aspects of the present invention, the display unit 350 and the input unit 360 may be a combined unit (such as a touch screen).

The interface unit 310 transmits image data to an interface unit (not shown) of an image forming apparatus 400. The terminal apparatus 300 may be connected to the image forming apparatus 400 directly through a cable or through a wired and/or wireless network (such as a local area network (LAN)).

The storage unit 320 stores registry data of a printer driver pre-installed in the terminal apparatus 300 and files relating to the printer driver. The storage unit 320 may be implemented as a folder in a hard disk drive (HDD) or a registry. Furthermore, the storage unit may be a volatile memory (such as RAM) or a non-volatile memory (such as ROM, flash memory, or a hard disk drive).

The user interface unit 330 receives a command to generate a printer driver package. When the command is input, the control unit 340 collects data used to generate the printer driver package, and generates a printer driver package having the same configuration as the printer driver pre-installed in the terminal apparatus. The user interface unit 330 may receive a command to generate the printer driver package of the image forming apparatus 400 by executing an application program stored in an external storage medium. However, it is understood that aspects of the present invention are not limited thereto. For example, the user interface unit 330 may receive the command by executing a printer driver program for the image forming apparatus 400 or a CD-ROM that is provided by the manufacturer of the image forming apparatus 400.

Referring to FIG. 4A, printer drivers for one or more image forming apparatuses are listed in a window 410 and include, for example, “ML-4550 Series PCL 6” of company A 412, “LaserJet 8150 Series PCL” of company B 414, “Stylus COLOR 1160 ESC/P 2” of company C 416, and “SCX 7100 Series PCL” of company D 418, are installed on the terminal apparatus 300 of the user. In this case, the user interface unit 330 may select “SCX 7100 Series PCL” of company D 418 as a printer driver of an image forming apparatus to generate the printer driver package from among the pre-installed one or more image forming apparatuses in the user interface screen 400 generated by executing a printer driver program or an application program.

When a printer driver of an image forming apparatus to perform printer driver packaging is selected, a command to generate a printer driver package can be input, for example, by clicking on a button “Generate Printer Driver Package,” 440 as illustrated in FIG. 4B.

When the command to generate the printer driver package is input, the control unit 340 collects data used to generate the printer driver package. In greater detail, the control unit 340 searches for a printer driver installation information file from among registry information of the pre-installed printer driver, and analyzes the searched printer driver installation information so that a list of files generated when the printer driver was installed, a list of files generated after the printer driver was installed, and registry data are searched for and copied into a folder. Consequently, data used to generate the printer driver package is collected.

The files generated when the printer driver was installed may be stored in the storage unit 320, and may be files relating to a default printer driver of an image forming apparatus provided by the manufacturer. The files generated after the printer driver was installed may also be stored in the storage unit 320, and may include a profile file, an overlay file, and a configuration file, setting values of which can be modified by adjusting the settings of the printer driver, and to which a new file can be added. In addition, the registry data may be stored in the storage unit 320 (for example, in a registry), and may include information regarding the location, type, and value of the registry data. The file lists and data used to generate the printer driver package may be collected in a predetermined folder in the terminal apparatus 300, or may be stored in a storage space (not shown) outside the terminal apparatus 300 (such as a universal serial bus (USB)).

When the file lists and data used to generate the printer driver package are collected, the control unit 340 generates the printer driver package to have the same configuration as the printer driver pre-installed in the terminal apparatus 300. More specifically, the control unit 340 generates a new printer driver installation information file by adding information regarding the file generated after the printer driver was installed to the existing printer driver installation information file. Subsequently, the control unit 340 packages the new printer driver installation information file and the data that has already been copied and stored in the folder as, for example, a compressed file in ZIP format so that a printer driver package can be generated.

After the printer driver package is generated, the control unit 340 converts the generated printer driver package to an executable file format. The executable file may be a file having a ZIP or .EXE extension, or may have various other extensions. In addition, the terminal apparatus 300 may further include a mini installer (not shown) to convert the generated printer driver package into an executable file format.

The generated printer driver package can be externally transmitted in order to facilitate redistribution to terminal apparatuses of other users. Furthermore, the generated printer driver package may be converted to an executable file format, and then externally transmitted. In other words, the generated printer driver package may be transmitted from an administrator of a network or a domain to external clients, and/or may be transmitted from the user's terminal apparatus 300 to a terminal apparatus of another user. In this case, users can receive a newly generated distribution and install the newly generated distribution using, for example, Add Printer Wizard in WINDOWS.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

As described above, according aspects of the present invention, even when a printer driver of an image forming apparatus that is installed in the terminal apparatus of the user is updated or modified to be adapted to a user environment, a printer driver package can be generated using the updated or modified printer driver, improving user convenience.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the files of the analyzed printer driver installation information file may be copied in a central server. Furthermore, the generated printer driver package may not be compressed before external transmission. Accordingly, it is intended, therefore, that the present invention not be limited to the various example embodiments disclosed, but that the present invention includes all embodiments falling within the scope of the appended claims.

What is claimed is:

1. A method of generating a printer driver package in a terminal apparatus that is connected to an image forming apparatus, the method comprising:
receiving a command to generate the printer driver package for the image forming apparatus;
collecting data to be included in the printer driver package in response to the command; and
generating the printer driver package based on a printer driver pre-installed in the terminal apparatus using the collected data.

2. The method as claimed in claim 1, further comprising:
externally transmitting the generated printer driver package.

3. The method as claimed in claim 1, wherein the receiving of the command to generate the printer driver package comprises:
displaying a user interface screen to select a printer driver installed in the terminal apparatus from among one or more displayed printer drivers.

4. The method as claimed in claim 1, wherein the generating of the printer driver package comprises generating the printer driver package to have a same configuration as the pre-installed printer driver.

5. The method as claimed in claim 1, further comprising:
converting the generated printer driver package to an executable file format.

6. The method as claimed in claim 1, wherein the receiving of the command to generate the printer driver package comprises:
displaying a user interface screen that is generated by executing a printer driver program or an application program.

7. The method as claimed in claim 1, wherein the collected data includes registry data of the pre-installed printer driver stored in the terminal apparatus when the printer driver is installed in the terminal apparatus, and/or a file relating to the pre-installed printer driver.

8. The method as claimed in claim 1, wherein the collecting of the data comprises:
searching for a printer driver installation information file from among registry data of the pre-installed printer driver; and
analyzing the searched printer driver installation information file to copy files generated when the pre-installed printer driver was installed, files generated after the pre-installed printer driver was installed, and registry data.

9. The method as claimed in claim 8, wherein the generating of the printer driver package comprises:
generating a new printer driver installation information file including installation information of the files generated after the printer driver was installed; and
generating the printer driver package by packaging the new printer driver installation information file with the copied data.

10. The method as claimed in claim 9, wherein the generating of the new printer driver installation information file comprises adding the installation information of the files generated after the printer driver was installed to the printer driver installation information file.

11. The method as claimed in claim 8, wherein the files generated when the pre-installed printer driver was installed include files relating to a default printer driver of an image forming apparatus.

12. The method as claimed in claim 8, wherein the files generated after the pre-installed printer driver was installed include a profile file, an overlay file, and/or a configuration file.

13. The method as claimed in claim 8, wherein the analyzing of the searched printer driver installation information file comprises copying the files generated when the pre-installed printer driver was installed, the files generated after the pre-installed printer driver was installed, and the registry data into an external storage unit.

14. The method as claimed in claim 2, wherein the external transmitting of the generated printer driver package comprises transmitting the generated printer driver package from an administrator of a network or a domain to clients of the network or the domain.

15. A computer-readable recording medium encoded with the method of claim 1 and implemented by at least one computer.

16. A terminal apparatus connected to an image forming apparatus, comprising:
a user interface unit to receive a command to generate a printer driver package for the image forming apparatus; and
a control unit to collect data used to generate the printer driver package when the command is received, and to generate the printer driver package based on a printer driver pre-installed in the terminal apparatus using the collected data.

17. The apparatus as claimed in claim 16, further comprising:
a storage unit to store registry data of the pre-installed printer driver, and/or a file relating to the pre-installed printer driver.

18. The apparatus as claimed in claim 16, wherein the user interface unit displays a user interface screen to select a printer driver installed in the terminal apparatus when a printer driver program or an application program is executed.

19. The apparatus as claimed in claim 16, wherein the control unit generates the printer driver package to have a same configuration as the pre-installed printer driver.

20. The apparatus as claimed in claim 16, wherein the control unit converts the generated printer driver package to an executable file format.

21. The apparatus as claimed in claim 16, wherein the collected data includes registry data of the pre-installed printer driver when the printer driver is installed in the terminal apparatus, and/or a file relating to the pre-installed printer driver.

22. The apparatus as claimed in claim 16, wherein the control unit searches for a printer driver installation information file from among registry data of the pre-installed printer driver, and analyzes the searched printer driver installation information file to copy files generated when the pre-installed printer driver was installed, files generated after the pre-installed printer driver was installed, and registry data.

23. The apparatus as claimed in claim 22, wherein the control unit generates a new printer driver installation information file including installation information of the files generated after the printer driver was installed, and generates the printer driver package by packaging the new printer driver installation information file with the copied data.

24. The apparatus as claimed in claim 16, further comprising a transmission unit to externally transmit the generated printer driver package.

25. A method of generating a printer driver package in a terminal apparatus that is connected to an image forming apparatus, the method comprising:
collecting data to be included in the printer driver package for the image forming apparatus; and
generating the printer driver package based on a printer driver pre-installed in the terminal apparatus using the collected data.
